(19) United States
(12) Patent Application Publication
(10) Pub. No.: US 2023/0215407 A1
(43) Pub. Date: Jul. 6, 2023

(54) ELECTRONIC MUSICAL INSTRUMENT, METHOD OF GENERATING MUSICAL SOUND, AND COMPUTER-READABLE STORAGE MEDIUM

(71) Applicant: CASIO COMPUTER CO., LTD., Tokyo (JP)

(72) Inventor: Goro SAKATA, Hamura-shi (JP)

(73) Assignee: CASIO COMPUTER CO., LTD., Tokyo (JP)

(21) Appl. No.: 18/181,807

(22) Filed: Mar. 10, 2023

Related U.S. Application Data
(63) Continuation of application No. PCT/JP2021/030230, filed on Aug. 18, 2021.

(30) Foreign Application Priority Data
Sep. 15, 2020 (JP) 2020-154615
Sep. 15, 2020 (JP) 2020-154616

(51) Int. Cl. G10H 1/10

(52) U.S. Cl. CPC G10H 1/10; G10H 2210/295; G10H 2210/245

(57) ABSTRACT

An electronic musical instrument according to one aspect of the invention is configured to generate, in response to an excitation signal corresponding to a specified pitch, a first string signal to be output from one of right and left channels based on a first accumulated signal in which outputs of at least a first closed-loop circuit and a second closed-loop circuit among the first closed-loop circuit, the second closed-loop circuit and a third closed-loop circuit, which are provided to correspond to the specified pitch, are accumulated, and generate a second string signal to be output from the other channel based on a second accumulated signal in which outputs of the second closed-loop circuit and the third closed-loop circuit are accumulated.

### CROSS-REFERENCE TO RELATED APPLICATIONS

This application is a Continuation Application of PCT Application No. PCT/JP2021/030230, filed Aug. 18, 2021 and based upon and claiming the benefit of priority from prior Japanese Patent Applications No. 2020-154615, filed Sep. 15, 2020; and No. 2020-154616, filed Sep. 15, 2020, the entire contents of all of which are incorporated herein by reference.

### FIELD

The present invention relates to an electronic musical instrument, a method of generating a musical sound, and a computer-readable storage medium.

### BACKGROUND

A technique of a resonance sound generating apparatus capable of simulating resonance sound of an acoustic piano more faithfully has been proposed (for example, Jpn. Pat. Appln. KOKAI Publication No. 2015-143764).

### SUMMARY

An electronic musical instrument according to one aspect of the invention comprises at least one processor configured to execute processing of generating, in response to an excitation signal corresponding to a specified pitch, a first string signal to be output from one of right and left channels based on a first accumulated signal in which outputs of at least a first closed-loop circuit and a second closed-loop circuit among the first closed-loop circuit, the second closed-loop circuit and a third closed-loop circuit, which are provided to correspond to the specified pitch, are accumulated, and generating a second string signal to be output from the other channel based on a second accumulated signal in which outputs of the second closed-loop circuit and the third closed-loop circuit are accumulated.

### BRIEF DESCRIPTION OF THE DRAWINGS

FIG. 1 is a block diagram showing a configuration of a basic hardware circuit of an electronic keyboard musical instrument according to one embodiment of the present invention.

FIG. 2 is a block diagram showing a function performed by a sound source DSP according to the embodiment as a configuration of a hardware circuit.

FIG. 3 is a diagram illustrating a frequency spectrum of a fundamental sound and a harmonic tone of a string sound according to the embodiment.

FIG. 4 is a diagram illustrating a frequency spectrum of a stroke sound according to the embodiment.

FIG. 5 is a diagram illustrating a frequency spectrum of a musical sound according to the embodiment

FIG. 6 is a diagram illustrating a concept of generating waveform data of a string sound by a closed-loop circuit from waveform data of an excitation impulse of the string sound according to the embodiment.

FIG. 7 is a table showing the relationship between the frequencies of string sounds assigned to a four-string model according to the embodiment and a beat caused by the difference among the frequencies.

### DETAILED DESCRIPTION

One embodiment of the present invention applied to an electronic keyboard musical instrument will be described below with reference to the drawings.

(Configuration)

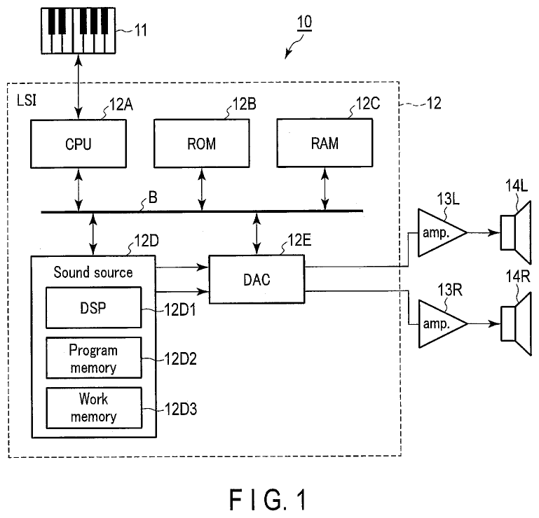

FIG. 1 is a block diagram showing a configuration of a basic hardware circuit of an electronic keyboard musical instrument 10 according to the embodiment. An operation signal including a note number (pitch information) and a velocity value (key-pressing speed) as sound volume information is input to a CPU 12A of an LSI 12 in response to an operation performed by a keyboard unit 11 that is a playing operator.

The LSI 12 includes the CPU 12A, a ROM 12B, a RAM 12C, a sound source 12D and a D/A converting unit (DAC) 12E, which are connected via a bus B.

The CPU 12A controls the entire operation of the electronic keyboard musical instrument 10. The ROM 12B stores operation programs to be executed by the CPU 12A, waveform data for excitation signals for playing, stroke sound waveform data, and the like. The RAM 12C is a work memory to execute the operation programs which are read and expanded from the ROM 12B by the CPU 12A. The CPU 12A supplies parameters, such as the note number and the velocity value, to the sound source 12D during playing.

The sound source 12D includes a digital signal processor (DSP) 12D1, a program memory 12D2 and a work memory 12D3. The DSP 12D1 reads an operation program and fixed data from the program memory 12D2, and develops and stores them on the work memory 12D3 to execute the operation program. In accordance with the parameters supplied from the CPU 12A, the DSP 12D1 generates stereo musical sound signals of the right and left channels by signal processing, based on the waveform data for an excitation signal of a necessary string sound and the waveform data of a stroke sound from the ROM 12B, and outputs the generated musical sound signals to the D/A converting unit 12E.

The D/A converting unit 12E analogizes the stereo musical sound signals and outputs them to their respective amplifiers (amp.) 13R and 13L. The amplifiers 13R and 13L amplify the analog right- and left-channel musical sound signals. In response to the amplified musical sound signals, speakers 14R and 14L amplify the musical sounds and output them as stereo sounds.

Note that FIG. 1 illustrates the configuration of a hardware circuit applied to the electronic keyboard musical instrument 10. If the function to be performed in the present embodiment is performed by an application program installed in an information processing device such as a personal computer, the CPU of the device executes the operation in the sound source 12D.

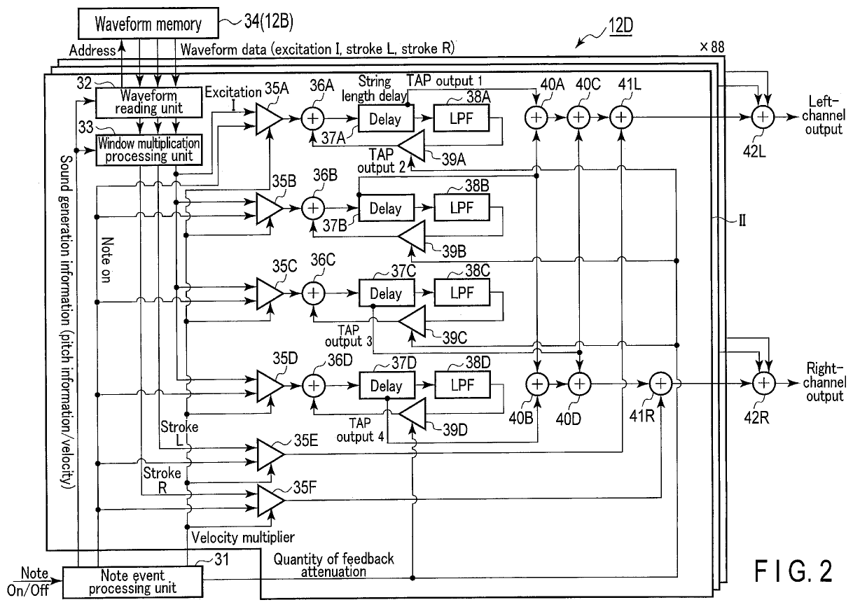

FIG. 2 is a block diagram showing the functions performed mainly by the DSP 12D1 of the sound source 12D, as a configuration of the hardware circuit. In the figure, the range indicated by II corresponds to one key included in the keyboard unit 11, except for a note event processing unit 31, a waveform memory 34 and adders 42R and 42L, which will be described later. In the electronic keyboard musical instrument 10, the keyboard unit 11 includes 88 keys and similar circuits for the 88 keys. The electronic keyboard musical instrument 10 includes a signal circulation circuit of a four-string model per key to generate a stereo musical sound signal.

The CPU 12A supplies the note event processing unit 31 with a note-on/off signal corresponding to the operation of a key of the keyboard unit 11.

In response to the key operation, the note event processing unit 31 sends information of each of a note number and a velocity value at the start of sound generation (note-on) to a waveform reading unit 32 and a window-multiplying processing unit 33, and sends a note-on signal and a multiplier corresponding to the velocity value to gate amplifiers 35A to 35F of each string model and stroke sound.

The note event processing unit 31 also sends a signal indicating the quantity of feedback attenuation to attenuation amplifiers 39A to 39D.

The waveform reading unit 32 generates a read address corresponding to the information of the note number and velocity value and reads waveform data as an excitation signal of the string sound and waveform data of the stroke sound from the waveform memory 34 (ROM 12B). Specifically, the waveform reading unit 32 reads an excitation impulse (excitation I) for generating a monaural string sound, and the waveform data of each of the right-channel stroke sound (stroke R) and the left-channel stroke sound (stroke L) from the waveform memory 34, and outputs them to the window-multiplying processing unit 33.

The window-multiplying processing unit 33 performs a window-multiplying process (window function) especially for the excitation impulse (excitation I) of a string sound with the duration corresponding to the wavelength of a pitch corresponding to a note number from note number information, and sends waveform data, which is obtained after the window-multiplying process, to gate amplifiers 35A to 35F.

First is a description of the stage subsequent to the gate amplifier 35A on the top state, which is one of the signal circulation (closed-loop) circuits of a four-string model. On the stage subsequent to the gate amplifier 35A, waveform data of temporally continuous left-channel string sounds is generated.

The gate amplifier 35A performs an amplification process for the waveform data obtained after the window-multiplying process with a multiplier corresponding to the velocity value, and outputs the waveform data to an adder 36A. The waveform data is attenuated by an attenuation amplifier 39A described later and fed back to the adder 36A. The adder 36A outputs the attenuated waveform data to a delay circuit 37A as the output of the string models. The delay circuit 37A sets a string length delay whose value corresponds to one wavelength of sound output upon a vibration of the string, to an acoustic piano, delays the waveform data by that string length delay, and outputs the delayed waveform data to a low-pass filter (LPF) 39A on the subsequent stage. That is, the delay circuit 37A delays the waveform data by time (time for one wavelength) determined according to the input note number information (pitch information).

The delay circuit 37A sets a delay time (TAP delay time) to shift a phase and outputs a result of the delay (TAP output 1) to an adder 40A. The output from the delay circuit 37A to the adder 40A corresponds to the waveform data of a string sound of the temporally continuous left-channel (for one string).

Waveform data at a lower frequency than the cutoff frequency for wide attenuation set for the frequency of the string length is caused to pass a low-pass filter 38A and output to the attenuation amplifier 39A.

The attenuation amplifier 39A performs an attenuation process in response to a signal of the feedback attenuation amount given from the note event processing unit 31, and feeds the attenuated waveform data back to the adder 36A.

On the stage subsequent to the gate amplifier 35B on a second stage, waveform data of a string sound at a first center position that is shared by the right and left channels is generated from the waveform data of the excitation impulse (excitation I) of the string sound.

The circuit configurations and operations of an adder 36B, a delay circuit 37B, a low-pass filter 38B and an attenuation amplifier 39B on the stage subsequent to the gate amplifier 35B are similar to those on the upper stage. TAP output 2 of the delay circuit 37B is output to adders 40A and 40B as waveform data of the string sound at the first center position.

The adder 40A adds the waveform data (TAP output 1) of the string sound of the left channel output from the delay circuit 37A and the waveform data (TAP output 2) of the string sound at the first center position output from the delay circuit 37B, and outputs the waveform data of the string sound of the left channel (for two strings) to an adder 40C as a result of the addition.

On the stage subsequent to the gate amplifier 35C on a third stage, waveform data of a string sound at a second center position that is shared by the right and left channels is generated from the waveform data of the excitation impulse (excitation I) of the string sound.

The circuit configurations and operations of an adder 36C, a delay circuit 37C, a low-pass filter 38C and an attenuation amplifier 39C on the stage subsequent to the gate amplifier 35C are similar to those on the upper stage. TAP output 3 of the delay circuit 37C is output to the adders 40C and 40D as waveform data of the string sound at the second center position.

The adder 40C adds the waveform data of the string sound of the left channel (for two strings) output from the adder 40A and the waveform data (TAP output 3) of the string sound at the second center position output from the delay circuit 37C, and outputs the waveform data of the string sound of the left channel (for three strings) to an adder 41L as a result of the addition (as a first accumulated signal).

On the stage subsequent to the gate amplifier 35D on a fourth stage, a string sound signal of the temporally continuous right channel is generated from the waveform data of the excitation impulse (excitation I) of the string sound.

The circuit configurations and operations of an adder 36D, a delay circuit 37D, a low-pass filter 38D and an attenuation amplifier 39D on the stage subsequent to the gate amplifier 35D are similar to those on the upper stage. TAP output 4 of the delay circuit 37D is output to the adder 40B. The output from the delay circuit 37D to the adder 40B corresponds to the waveform data of a string sound of the temporally continuous right-channel (for one string).

The adder 40B adds the waveform data (TAP output 4) of the string sound of the right channel output from the delay circuit 37D and the waveform data (TAP output 2) of the string sound at the first center position output from the delay circuit 37B, and outputs the waveform data of the string sound of the right channel (for two strings) to an adder 41D as a result of the addition.

The adder 40D adds the waveform data of the string sound of the right channel (for two strings) output from the adder 40B and the waveform data (TAP output 3) of the string sound at the second center position output from the delay circuit 37C, and outputs the waveform data of the string sound of the right channel (for three strings) to an adder 41R as a result of the addition (as a second accumulated signal).

The adder 41L adds the waveform data of the string sound of the left channel output from the adder 40C and the waveform data of the stroke sound of the left channel output from a gate amplifier 35E, and outputs to the adder 42L a result of the addition as the waveform data of a musical sound (as a first string signal) on which the string sound and stroke sound of the left channel are superposed.

The adder 41R adds the waveform data of the string sound of the right channel output from the adder 40B and the waveform data of the stroke sound of the right channel output from a gate amplifier 35F, and outputs to the adder 42R a result of the addition as the waveform data of a musical sound (as a second string signal) on which the string sound and stroke sound of the right channel are superposed.

The adder 42L adds the waveform data of musical sounds of the left channels of keys pressed by the keyboard unit 11 and outputs the sum of the waveform data to the D/A converting unit 12E on the next stage for generation of the musical sounds.

Similarly, the adder 42R adds the waveform data of musical sounds of the right channels of keys pressed by the keyboard unit 11 and outputs the sum of the waveform data to the D/A converting unit 12E on the next stage for generation of the musical sounds.

It has been described that in the configuration shown in FIG. 2, the waveform data of the monaural excitation impulse is input to the closed-loop circuit of the four-string model. The circuit configuration may be more simplified by reducing the gate amplifier 35C on the third stage, which generates the waveform data of a string sound in a second center position shared by the right and left channels, and the closed-loop circuit on the subsequent stage, by one string, and inputting the waveform data to the closed-loop circuit of a three-string model.

(Operation)

Next is a description of the operation of the above embodiment.

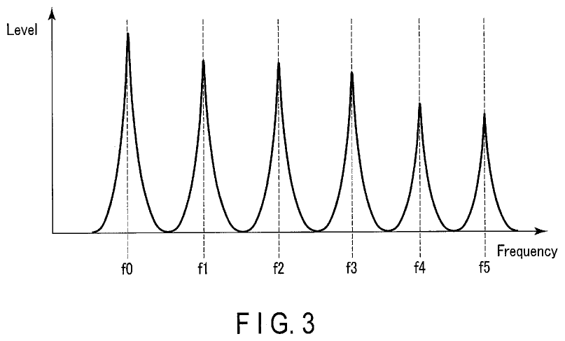

With reference to FIGS. 3 to 5, first, the concept of superposing and adding string and stroke sounds to generate a musical sound, will be described.

FIG. 3 is a diagram illustrating the frequency spectrum of a string sound. As shown in the figure, the frequency spectrum has a peak-shaped fundamental sound f0 and its harmonic tones f1, f2, . . . which are continuous.

In addition, waveform data of a plurality of string sounds having different pitches can be generated by applying a process of shifting the frequency components of the fundamental sound f0 and its harmonic tones f1, f2, and . . . to the waveform data of the string sound of the frequency spectrum.

The string sound that can be generated by the physical model as described above contains nothing but the fundamental sound components and harmonic tones, as shown in FIG. 3. On the other hand, the musical sound generated by the original musical instrument contains a musical sound component that can also be referred to as a stroke sound, and this musical sound component characterizes the musical sound of the musical instrument. For this reason, it is desirable for electronic musical instruments to generate a stroke sound and synthesize it with a string sound.

In the present embodiment, for example, in an acoustic piano, the stroke sound contains sound components, such as sound of collision generated in response to a hammer colliding with a string inside the piano by key pressing, an operating sound of the hammer, a key-stroke sound by piano player's fingers, and sound generated by a key hitting and stopping on a stopper, and does not contain components of pure string sounds (fundamental sound component and harmonic tone component of each key). The stroke sound is not always limited to a physical stroke operation sound itself generated at the time of key pressing.

To generate the stroke sound, the waveform data of the recorded musical sound is first window-multiplied by a window function such as a Hanning window, and then converted into frequency-dimensional data by fast Fourier transform (FFT).

For the converted data, the frequencies of the fundamental sound and harmonic tones are determined based on data that can be observed from the recorded waveform, such as pitch information of the recorded waveform data, a harmonic tone to be removed and a deviation of the harmonic tone frequency from the fundamental sound, and an arithmetic operation is performed so that the amplitude of result data at those frequencies becomes 0, thereby removing the frequency components of the string sound.

If the fundamental sound frequency is, for example, 100 Hz, frequencies at which the frequency component of a string sound is removed by multiplication using multiplier 0 are 100 Hz, 200 Hz, 400 Hz, 800 Hz, . . . .

It is assumed here that the harmonic tones are exactly integral multiples. Since, however, the frequencies of actual musical instruments deviate slightly, using harmonic tone frequencies to be observed from the waveform data obtained by recording is adaptable more appropriately.

After that, the waveform data of the stroke sound can be generated by converting the data obtained by removing the frequency component of the string sound into time dimension data by inverse fast Fourier transform (IFFT).

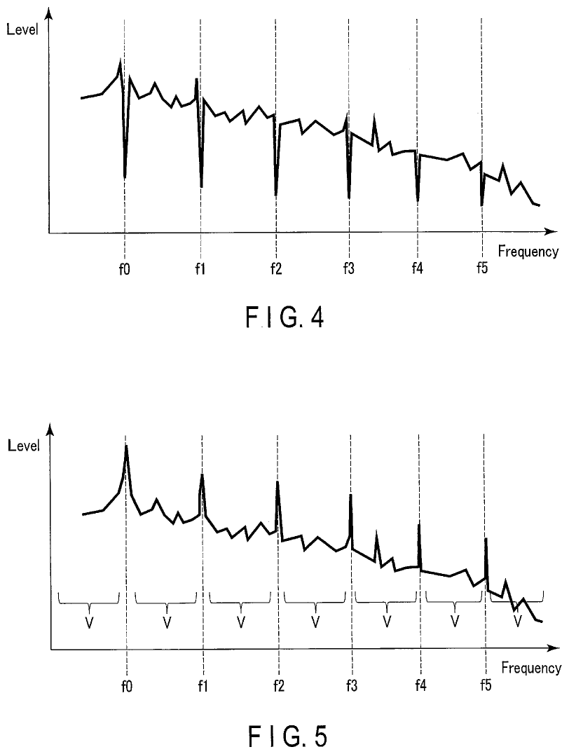

FIG. 4 is a diagram illustrating the frequency spectrum of a musical sound of a stroke sound. The waveform data of the stroke sound having such a frequency spectrum is stored in the waveform memory 34 (ROM 12B).

By adding and synthesizing the waveform data of the stroke sound of FIG. 4 and the waveform data of the string sound generated from the physical model shown in FIG. 3, a musical sound having a frequency spectrum as shown in FIG. 5 is generated.

FIG. 5 is a diagram illustrating the frequency spectrum of a musical sound generated in response to key-pressing of a note with a pitch f0 on the acoustic piano. As shown, the musical sound of the acoustic piano can be reproduced by synthesizing a string sound in which the peak-shaped fundamental sound f0 and its harmonic tones f1, f2, . . . continue and a stroke sound generated in gaps V, V, . . . of the peak-shaped string sound.

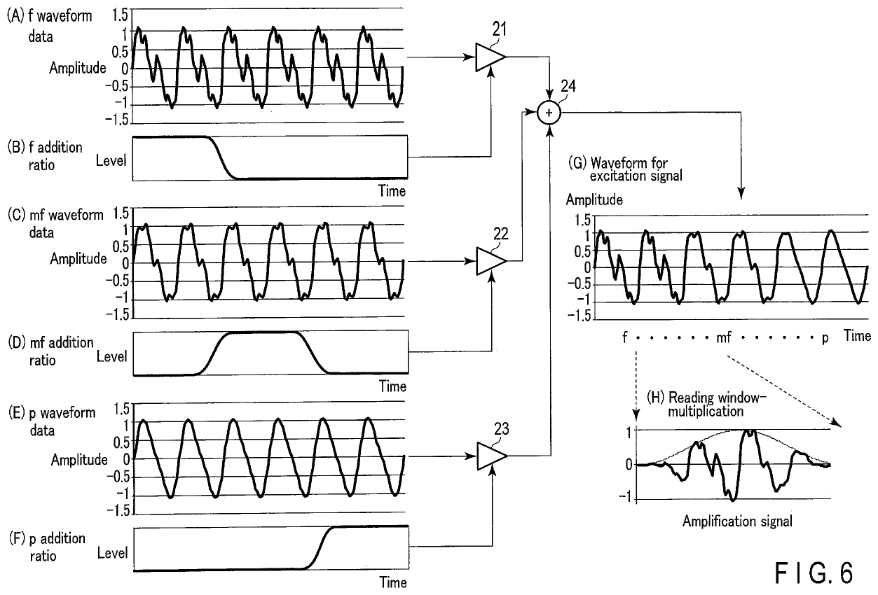

With reference next to FIG. 6, the concept of generating waveform data of temporally continuous string sounds by closed-loop circuits (36A to 39A, 36B to 39B, 36C to 39C, 36D to 39D) constituting a string model, from the waveform data of excitation impulse of a string sound read from the waveform memory 34 (ROM 12B) will be described.

FIG. 6 is a diagram illustrating a method of generating an excitation signal from the added and synthesized strong and weak waveforms at a pitch corresponding to a certain note number. The data of the beginning of waveform data according to the strength and weakness are added with the values shown by the addition ratio indicated in the figure such that the strength changes along the same time series as the progress of the stored address.

Specifically, (A) in FIG. 6 shows about six periods of forte (f) waveform data, which is first waveform data of high intensity (sound is strong). As shown in (B) in FIG. 6, an addition ratio signal is supplied to the waveform data to validate about first two periods. Thus, a multiplier (amplifier) 21 multiplies the waveform data using the addition ratio signal, which varies between “1.0” and “0.0,” as a multiplier (amplification factor), and supplies an adder 24 with waveform data that is a product obtained by the multiplication.

Similarly, (C) in FIG. 6 shows about six periods of mezzo forte (mf) waveform data, which is second waveform data of moderate intensity (the intensity of sound is slightly high). As shown in (D) in FIG. 6, an addition ratio signal is supplied to the waveform data to validate about middle two periods. Thus, a multiplier 22 multiplies the waveform data using the addition ratio signal as a multiplier, and supplies the adder 24 with waveform data that is a product obtained by the multiplication.

Similarly, (E) in FIG. 6 shows about six periods of piano (p) waveform data, which is third waveform data of low intensity (sound is weak). As shown in (F) in FIG. 6, an addition ratio signal is supplied to the waveform data to validate about last two periods. Thus, a multiplier 23 multiplies the waveform data using the addition ratio signal as a multiplier, and supplies the adder 24 with waveform data that is a product obtained by the multiplication.

Therefore, the output of the adder 24, which adds the foregoing waveform data, continuously changes in waveform from strong to medium to weak every two periods, as shown in (G) of FIG. 6.

The waveform memory 34 (ROM 12B) stores waveform data (waveform data for excitation signals) as described above, and reads necessary waveform data (partial data) as an excitation impulse signal of a string sound by specifying a start address corresponding to the intensity of playing. As shown in (H) of FIG. 6, the read waveform data is window-multiplied by the window-multiplying processing unit 33 and supplied to a signal circulation (closed-loop) circuit in each of the subsequent stages to generate waveform data of temporally continuous string sounds.

Since two to three wavelengths are used as waveform data, the number of sampling data constituting the waveform data varies with pitch. For example, in the case of an acoustic piano with 88 keys, the number of sampling data is about 2000 to 20 (at a sampling frequency of 44.1 kHz) from a low sound to a high sound.

Note that the above-described waveform data adding method is not limited to the combination of waveform data with different playing intensities of the same instrument. For example, an electric piano has a waveform characteristic similar to a sine wave if a key is struck weakly, while it has a waveform shape like a saturated square wave if a key is struck strongly. Musical sounds of different instruments with the above waveforms having distinctly different shapes, waveforms extracted from, for example, a guitar, and the like can continuously be added together to generate modelling sounds that are continuously changed by the intensity of playing and another playing operator.

Next is a description of the relationship between the frequency of a stereo string sound and the beat generated by the signal circulation (closed-loop) circuit of the four-string model shown in FIG. 2.

Beat that is simply referred to in piano music sound generally indicates the phase of a fundamental wave. In the present embodiment, in order to generate a musical sound with a sense of stereo, delay time and TAP delay are set such that the amplitude of each of harmonic tone components is output with a phase shift between the right and left channels due to a beat phenomenon generated by each harmonic tone including the fundamental wave.

In the configuration shown in FIG. 2, the outputs of string models are delayed with different phases from a first loop, and the beat periods of the string models are different. The tops of the signal waveforms of the harmonic tone components are shifted greatly in phase in the right and left channels. It is thus possible to generate a musical sound with a rich sense of stereo immediately after a key is struck at the keyboard unit 11.

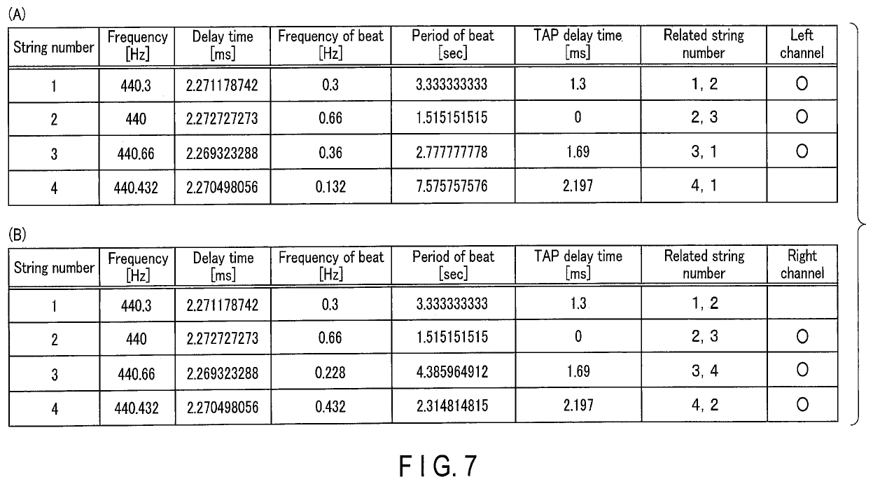

FIG. 7 is a table showing the relationship between the frequencies of string sounds assigned to four string models and a beat caused by the difference among the frequencies in a case where the note number key-pressed at the keyboard unit 11 is, for example, A4 “A” (440 Hz). In FIG. 7, (A) shows the relationship between the frequency of string sound of the left channel and the beat, and (B) shows the relationship between the frequency of string sound of the right channel and the beat. If the closed-loop circuits of the four string sounds shown in FIG. 2 are string model numbers “1” to “4” in order from the top stage, the original frequency of 440 Hz is assigned to the string model of a first center position of number “2” that is a shared string model, the frequency of 440.66 Hz is assigned to the string model of a second center position of number “3” that is a shared string model. 440.3 Hz is assigned to the string model of the left channel of number “1” and 440.432 Hz is assigned to the string model of the right channel of number “4.” The waveform data of excitation impulse of the string sound of each of the frequencies is read out and given to its corresponding string model. The ratio of the assigned frequencies is set on the basis of an index. The string-length delay time of each of the string models in the delay circuits 37A to 37D is set to one period of the wavelength of its corresponding one of the assigned frequencies.

TAP delay time as shown in FIG. 7 is set to the TAP outputs 1 to 4 that are output from the delay circuits 37A to 37D with a delay time set to shift the phase. That is, TAP delay time at number “2” to which the original frequency of 440 Hz is assigned is set to “0,” TAP delay time at number “1” is set to 1.3 “ms,” TAP delay time at number “3” is set to 1.69 “ms” and TAP delay time at number “4” is set to 2.197 “ms.”

Thus, in the closed-loop circuits (36A to 39A) with, for example, number “1,” the waveform data of the excitation impulse loops through the feedback circuit once for every 2.271178742 ms per period, which is the delay time to determine the pitch.

In a first loop, upon elapse of the set TAP delay time of 1.3 ms from the point of time at which the waveform data of the excitation impulse is input to the delay circuit 37A, it is output to the adder 40A as TAP output 1, and then the waveform data that gradually attenuates repeatedly every 2.271178742 ms is output as TAP output 1.

The TAP delay time to obtain the TAP outputs 1 to 4, which is set to the delay circuits 37A to 37D, is given by the following equation:

DelayT(n)=DelayINIT×DelayGAINn

where DelayT(n) is TAP delay time (ms), DelayINIT is an initial value (e.g. 7 ms), and DelayGAIN is a constant (e.g., 1.3).

In the equation, n is 0 to 3 and is set in relation to the string number. If string number is 1 (delay circuit 37A), n is 1. If string number is 2 (delay circuit 37B), n is 0. If string number is 3 (delay circuit 37C), n is 2. If string number is 4 (delay circuit 37D), n is 3.

As a result, the TAP delay time is calculated as an exponential series of numbers instead of an integral multiple, such as 0 ms, 1.3 ms, 1.69 ms and 2.197 ms, and set to each string model. Accordingly, the frequency characteristics obtained in instances where the string sounds of the string models are added together can be made as uniform as possible.

Six different frequency beat components are generated from four string models, and a musical sound to which one beat component common to two different beat components is assigned to the right and left channels that constitute a stereo sound, is generated. It is thus possible to generate a musical sound with a rich sense of stereo.

In addition, assuming that a typical electronic piano requires three string models per key, it requires two sets of three string models, that is, six string models for stereo sound generation. In the configuration shown in FIG. 2, however, two string models are shared and thus the four string models are used to generate a stereo sound, thereby greatly reducing the amount of signal processing.

Furthermore, in the configuration shown in FIG. 2, two string models of numbers “2” and “3” are provided as the shared center position string models, and a string sound of each of the right and left channels is generated from three string models. Therefore, in an environment where musical sounds of right and left channels are not mixed in space, such as an environment where musical sounds are reproduced by headphones or the like, even if only the musical sound of one of the right and left channels is heard, the possibility of feeling monotony in the heard musical sound can be eliminated with reliability.

### Effects of Embodiment

As described in detail above, according to the present embodiment, a musical sound with a good stereo feeling can be generated from the beginning of sound generation while suppressing the amount of signal processing.

In the present embodiment, furthermore, a stereo musical sound is generated by superposing and adding stroke sounds unique to a musical instrument in addition to a string sound containing the components of a specified pitch and its harmonic tones. Thus, a more natural musical sound can be generated satisfactorily while suppressing the amount of signal processing.

As described above, the present embodiment is applied to an electronic keyboard musical instrument, but the present invention is not limited to a musical instrument or a specific model.

The invention of the present application is not limited to the embodiment described above, but can be variously modified in the implementation stage without departing from the scope of the invention. In addition, the embodiments may be suitably implemented in combination, in which case a combined effect is obtained. Furthermore, inventions in various stages are included in the above-described embodiments, and various inventions can be extracted by a combination selected from a plurality of the disclosed configuration requirements. For example, even if some configuration requirements are removed from all of the configuration requirements shown in the embodiments, a problem can be solved, and if an effect is obtained, a configuration from which this configuration requirement is removed can be extracted as an invention.

1. An electronic musical instrument comprising:
at least one processor configured to execute processing of:
generating, in response to an excitation signal corresponding to a specified pitch, a first string signal to be output from one of right and left channels based on a first accumulated signal in which outputs of at least a first closed-loop circuit and a second closed-loop circuit among the first closed-loop circuit, the second closed-loop circuit and a third closed-loop circuit, which are provided to correspond to the specified pitch, are accumulated; and
generating a second string signal to be output from the other channel based on a second accumulated signal in which outputs of the second closed-loop circuit and the third closed-loop circuit are accumulated.

2. The electronic musical instrument according to claim 1, wherein the excitation signal circulates through the first closed-loop circuit, the second closed-loop circuit and the third closed-loop circuit with different delay times.

3. The electronic musical instrument according to claim 1, wherein the first and second accumulated signals are generated by accumulating signals tapped out with different tap delay times set in the first closed-loop circuit, the second closed-loop circuit and the third closed-loop circuit.

4. The electronic musical instrument according to claim 3, wherein the tapped outputs are provided to vary a phase of signals output from the first closed-loop circuit, the second closed-loop circuit and the third closed-loop circuit.

5. The electronic musical instrument according to claim 3, wherein the tap delay times are calculated by an equation including an index.

6. The electronic musical instrument according to claim 1, wherein the first string signal is generated based on the first accumulated signal and a first stroke sound signal and wherein the second string signal is generated based on the second accumulated signal and a second stroke sound signal.

7. The electronic musical instrument according to claim 1, wherein the excitation signal varies according to a specified velocity.

8. A method comprising:
generating, in response to an excitation signal corresponding to a specified pitch, a first string signal to be output from one of right and left channels based on a first accumulated signal in which outputs of at least a first closed-loop circuit and a second closed-loop circuit among the first closed-loop circuit, the second closed-loop circuit and a third closed-loop circuit, which are provided to correspond to the specified pitch, are accumulated, by a computer; and
generating a second string signal to be output from the other channel based on a second accumulated signal in which outputs of the second closed-loop circuit and the third closed-loop circuit are accumulated, by the computer.

9. The method according to claim 8, wherein the excitation signal circulates through the first closed-loop circuit, the second closed-loop circuit and the third closed-loop circuit with different delay times.

10. The method according to claim 8, wherein the first and second accumulated signals are generated by accumulating signals tapped out with different tap delay times set in the first closed-loop circuit, the second closed-loop circuit and the third closed-loop circuit.

11. The method according to claim 10, wherein the tapped outputs are provided to vary a phase of signals output from the first closed-loop circuit, the second closed-loop circuit and the third closed-loop circuit.

12. The method according to claim 10, wherein the tap delay times are calculated by an equation including an index.

13. The electronic musical instrument according to claim 8, wherein the first string signal is generated based on the first accumulated signal and a first stroke sound signal and wherein the second string signal is generated based on the second accumulated signal and a second stroke sound signal.

14. The electronic musical instrument according to claim 8, wherein the excitation signal varies according to a specified velocity.

15. A non-transitory computer-readable storage medium having a program stored thereon which controls a computer, to perform functions comprising:
generating, in response to an excitation signal corresponding to a specified pitch, a first string signal to be output from one of right and left channels based on a first accumulated signal in which outputs of at least a first closed-loop circuit and a second closed-loop circuit among the first closed-loop circuit, the second closed-loop circuit and a third closed-loop circuit, which are provided to correspond to the specified pitch, are accumulated; and
generating a second string signal to be output from the other channel based on a second accumulated signal in which outputs of the second closed-loop circuit and the third closed-loop circuit are accumulated.
